(19) United States
(12) Patent Application Publication
(10) Pub. No.: US 2009/0179416 A1
(43) Pub. Date: Jul. 16, 2009

(54) Spill stopper and message display

(75) Inventors: Kenneth Vivian Young, Gardena, CA (US); Michael Lasha Lincoln, Los Angeles, CA (US)

Correspondence Address: STEPTOE & JOHNSON LLP, 1330 CONNECTICUT AVENUE, N.W., WASHINGTON, DC, 20036, US

(73) Assignee: Vivan-Linc Inc., Inglewood, CA (US)

(21) Appl. No.: 12/096,337

(22) PCT Filed: Dec. 6, 2006
(86) PCT No.: PCT/US06/46419

§ 371 Date: Nov. 4, 2008

Related U.S. Application Data
(60) Provisional application No. 60/742,645, filed on Dec. 6, 2005.

(51) Int. Cl. B42D 15/00; B65D 51/00

(52) U.S. Cl. 283/67; 283/56; 220/376

(57) ABSTRACT

A method of advertising is provided in which a stopper having substantially parallel sides is inserted into a hole in a container, and a message is displayed on, a surface of the stopper towards a thicker end of the stopper and external to the container.

### CROSS-REFERENCE TO RELATED APPLICATIONS

This application claims priority from Provisional Patent application No. U.S. 60/742,645, filed on Dec. 6, 2005.

### TECHNICAL FIELD

The invention relates to a stopper and message display, and method for displaying a message and preventing spills.

### BACKGROUND

When a customer gets coffee to go, the coffee often comes with a lid with a small opening in it from which the customer can sip the coffee. While the lid keeps much of the coffee from spilling, coffee still escapes from the opening when the cup is jostled. This can happen when a person is walking, getting into a car, or driving, for example. As a result, the coffee can burn the person or spill in their car.

### SUMMARY

A stopper can be used to reduce the likelihood of liquid spilling from a vessel. The stopper can also provide a way to advertise.

In one aspect, a method of advertising includes inserting a stopper having substantially parallel sides into a hole in a container, and displaying a message on a surface of the stopper towards a thicker end of the stopper and external to the container.

In another aspect, an apparatus includes a stopper with substantially parallel length sides and width sides that are narrower than the length sides, the width sides becoming progressively smaller from one end of the stopper to the opposite end. In certain embodiments, the apparatus can include a message on a surface of the stopper towards the thick end.

In certain embodiments, the hole in the container can be a hole in a lid. The method can also include stopping a liquid from exiting the hole in the lid with the stopper. The stopper can be inserted by placing a thin end of the stopper into the hole. The stopper can include a thick end outside the hole. The message can include a logo or an advertisement. One end or each end of the stopper can be rounded, for example, substantially oval-shaped. The message can include an advertisement or a logo. The message can be embossed on the surface of the stopper, embedded in the surface of the stopper, or printed on the surface of the stopper. The stopper can be plastic or wood.

The details of one or more embodiments are set forth in the accompanying drawings and the description below. Other features, objects, and advantages will be apparent from the description and drawings, and from the claims.

### BRIEF DESCRIPTION OF THE DRAWING

FIG. 1 is a frontal view of the stopper.

FIG. 2A is a view from the thick end of the stopper.

FIG. 2B is a view from the narrow end of the stopper.

FIG. 3 is a side view of the stopper.

FIG. 4 is a view of the stopper in use.

### DETAILED DESCRIPTION

A stopper can be used in a method of keeping a hot coffee product inside a cup and preventing it from spilling out of the sipping hole at the top of the lid by plugging the hole. In addition, the stopper can provide a way for vendors to advertise, because the name of the coffee vendor is displayed on a surface of the stopper.

One advantage of the method and device is that it keeps coffee from spilling out of the cup so a customer who transports the coffee via an automobile isn't concerned about the coffee product staining the carpet or dripping into a cup holder.

Another advantage is that customers don't have to drive with their fingers over the hole in the lid and therefore the coffee won't burn their fingers.

When transporting coffee in a cup that utilizes a lid, the stopper is wedged in to the sipping hole in the coffee cup lid and acts as a barrier to keep the coffee from exiting the hole in the coffee cup lid.

The stopper can be created from a food grade plastic instead of a food grade resin. It can also be created in different sizes, and different styles of advertisement can be utilized on the body of the stopper.

The stopper can also be used as a way for the coffee vendor to track how many coffees a customer has purchased. When a customer accumulates enough stoppers, they may be redeemed for more coffee products sold by the vendor.

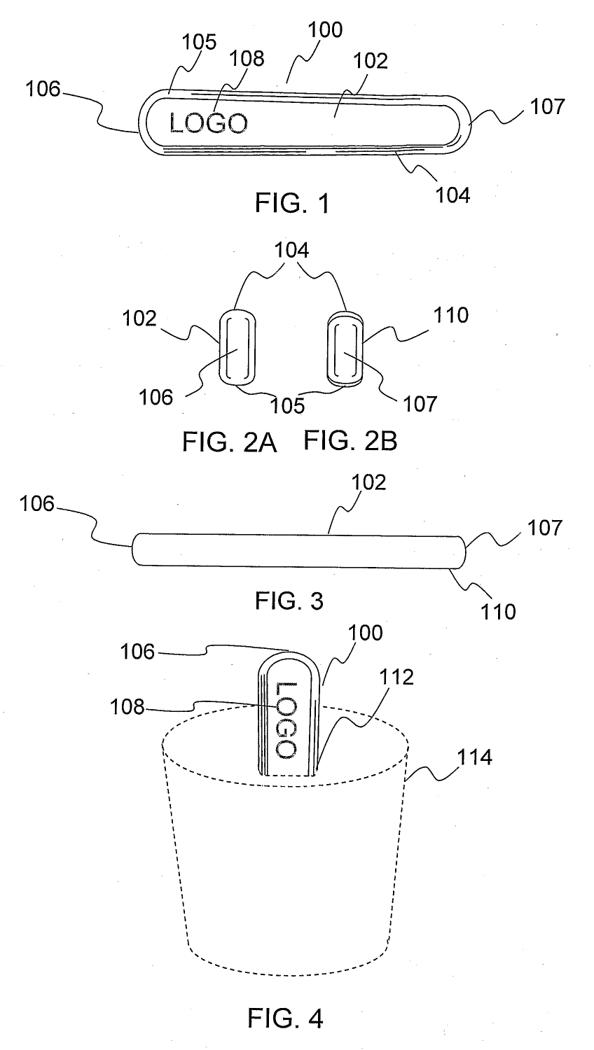

Referring to FIG. 1, the stopper 100 includes a front surface 102, a first side 104, a second side 105, a first end 106, and a second end 107. Each side 104 and 105 can be straight or rounded so that they do not have sharp edges. Each end 106 and 107 can be straight or rounded into oval or semi-circular shapes. The ends 106, 107 can also be 5 square, hexagonal, or any other similar shape. The length of the stopper 100 is long and narrow relative to the width. The ratio or the average length to the average width of the stopper 100, the lengthwise aspect ratio, can be 3:1, 4:1, 5:1, 6:1, 7:1, 8:1, 9:1, 10:1 or greater. A message 108, such as a logo, is printed or engraved on the wider end of the front surface.

Along its length, stopper 100 tapers in width in at least one dimension so that it is slightly wider at one end than the other. In some embodiments, the stopper 100 can taper in width in two dimensions. Referring to FIGS. 2A and 2B, the two ends 106 and 107 of the stopper 100 can have different cross-sectional areas, tapering from wide to small. The front surface 102 and back surface 110 of the stopper 100 can be substantially flat and substantially parallel. In certain embodiments, the front surface 103 and back surface 110 can also form a taper which narrows along the dimension from the end 106 to the end 107. The sides 104, 105 can be rounded. FIG. 2A represents an end view of stopper 100 showing end 106, the wider of the two ends. FIG. 2B represents an end view of stopper 100 showing end 107, the narrower of the two ends. The wide end 106 may be seen from the narrow end 107.

Referring to FIG. 3, a side view of stopper 100 shows ends 106 and 107, each of which can be rounded so that it does not have sharp comers, and the front surface 102 and back surface 110 of the stopper can be flat and can be substantially parallel. The depth of the stopper is narrow compared to the length. For example, the ratio, or the average length to the average depth, of the stopper 100 can be 4:1, 5:1, 6:1, 7:1, 8:1, 9:1, 10:1 or greater

The stopper can be made of a light weight material, such as a plastic, a rubber, a foam, wood, glass, a ceramic or a metal. A number of plastics may be used to form the stopper such as styrenes, polyolefins, polyesters, phenolics, cellulosics, or amino resins. Also, a number of methods may be used to make the stopper such as injection molding, compression molding, or cutting.

FIG. 4 illustrates the stopper 100 in use. The narrow end of the stopper 100 is inserted into an opening 112 in a container 114. For example, the container can be a coffee cup with a lid, and the opening is the narrow slit in a coffee-cup lid. Since one end of the stopper is wider, it does not fit in the opening 112, and it prevents the stopper from completely entering the container 114. It also prevents liquids, such as coffee in a coffee-cup, from spilling out of the container. This is possible because the cross-section of the stopper 100 is the same size and shape as the opening 112 in the container 114. Thus, when the narrow end 107 of the stopper 100 is inserted, it forms a seal, preventing spillage.

The wider end 106 of the stopper 100 has a message 108, such as a logo, imprinted on it, and the logo remains outside the container 114. The message 108 can be added in a number of ways. For example, it can be engraved, embossed, or printed on the surface. Also, the message 108 can be a logo, advertisement, a personalized message, or any other message. When the narrow end 107 of the stopper 100 is placed in the opening 112, the wider end 106 sticks out. The wider end 106 of the stopper 100 can be designed to extend a certain distance from the opening 112 in the container 114 so that the message 108 remains visible to the person-using the container 114. The width and depth of the stopper 100 can be designed so that only 50% of the stopper 100 enters the opening 112, the protruding 50% having the message 108 visible. For a longer message 108, the stopper 100 can be designed so that 10% or 20% of the stopper 100 enters the opening 112; for a shorter message 108, more than 50% of the stopper 100 can enter the opening 112. Thus, a company can advertise by imprinting a name or slogan on a stopper 100, and the stopper 100 can simultaneously prevent coffee or another liquid from spilling out of the container 114.

While the invention has been described in detail with reference to preferred embodiments thereof, it will be apparent to one skilled in the art that various changes can be made, and equivalents employed, without departing from the scope of the invention.

What is claimed is:

1. A method of advertising comprising:
inserting a stopper having substantially parallel sides into a hole in a container; and
displaying a message on a surface of the stopper towards a thicker end of the stopper and external to the container.

2. The method of claim 1, wherein the hole in the container is a hole in a lid.

3. The method of claim 2, further comprising stopping a liquid from exiting the hole in the lid with the stopper.

4. The method of claim 1, wherein inserting the stopper includes placing a thin end of the stopper into the hole.

5. The method of claim 4, wherein the stopper includes a thick end outside the hole.

6. The method of claim 1, wherein the message includes a logo or an advertisement.

7. An apparatus comprising:
a stopper with substantially parallel length sides and width sides that are narrower than the length sides, the width sides becoming progressively smaller from one end of the stopper to the opposite end.

8. The apparatus of claim 7, further comprising a message on a surface of the stopper towards the thick end.

9. The apparatus of claim 7, wherein one end of the stopper is rounded.

10. The apparatus of claim 7, wherein each end the stopper is rounded.

11. The apparatus of claim 7, wherein one end of the stopper is substantially oval-shaped.

12. The apparatus of claim 7, wherein each end of the stopper is substantially oval-shaped.

13. The apparatus of claim 7, wherein the stopper is plastic.

14. The apparatus of claim 7, wherein the stopper is wood.

15. The apparatus of claim 8, wherein the message includes an advertisement or a logo.

16. The apparatus of claim 8, wherein the message is embossed on the surface of the stopper.

17. The apparatus of claim 8, wherein the message is embedded in the surface of the stopper.

18. The apparatus of claim 8, wherein the message is printed on the surface of the stopper.
